(19) United States
(12) Patent Application Publication
(10) Pub. No.: US 2020/0051183 A1
(43) Pub. Date: Feb. 13, 2020

(54) POWER GENERATION SCHEDULING OPTIMIZATION

(71) Applicant: Cube Hydro Partners, LLC, Bethesda, MD (US)

(72) Inventors: Walter Neal Simmons, Bahama, NC (US); Connor James Tinen, Brooklyn, NY (US); Ian Eldridge-Allegra, Columbus, OH (US); Jonathon Ryan Gillespie, San Francisco, CA (US)

(21) Appl. No.: 16/451,002

(22) Filed: Jun. 24, 2019

Related U.S. Application Data
(60) Provisional application No. 62/689,244, filed on Jun. 24, 2018.

(51) Int. Cl. G06Q 50/06; G06Q 10/06; G06Q 30/02

(52) U.S. Cl. CPC G06Q 50/06; G06Q 30/0201; G06Q 10/06313

(57) ABSTRACT

A computer-implemented method of unit scheduling optimization for a hydroelectric plant in a bilateral market includes: minimizing flow of water through the hydroelectric plant to meet a generation schedule, wherein integer linear programming is used for the minimizing and a set of constraints used for the minimizing includes a minimum dissolved oxygen concentration downstream of the hydroelectric plant. The minimum dissolved oxygen concentration downstream of the hydroelectric plant may be at least 6.0 milligrams per liter. The hydroelectric plant may include at least two turbines disposed in the flow of water in a cascading arrangement.

### CROSS-REFERENCE TO RELATED APPLICATION

This application claims the benefits of U.S. Provisional Application No. 62/689,244 filed Jun. 24, 2018 by Connor James Tinen, Walter Neal Simmons, Ian Eldridge-Allegra, and Jonathon Ryan Gillespie and entitled “Power Generation Scheduling Optimization” under 35 U.S.C. § 119(e) and the entire contents of that application are expressly incorporated herein by reference thereto.

### FIELD OF THE INVENTION

The invention relates to power generation scheduling optimization. More particularly, the invention relates to optimizing performance of a plurality of generators available for generating a desired amount of power. The invention further relates to optimizing the performance of a hydroelectric plant by dividing a power demand among a plurality of generating units (e.g., turbines).

### BACKGROUND OF THE INVENTION

In those markets that are “free markets” for electricity, open competition is permitted for the purchase and sale of electricity each day and at any time of the day. By comparison, in bilateral markets, buyers contract directly with sellers, for example in “day ahead sales” and in “real time sales.”

During summer months, prices for electricity usually peak in the afternoon, matching the height of air conditioning loads. Because electricity prices are highest during the afternoon hours, a plant potentially could be operated so as to generate maximum power during those hours. But, there is limited available generation that can come online, on demand. Hydroelectric plants can respond very quickly to a short-term demand for power at a particular time. In other words, hydroelectric plants can be turned on, and shut off, very quickly. At the opposite end of the spectrum, solar power does not provide any dispatchability. In other words, there is no control of when the sun will be shining even during daylight hours (e.g., it could be overcast or rainy), so power production cannot be ensured. In the middle of the spectrum lies other forms of generation, such as coal power, which have lead times for increasing production. Such plants simply cannot be quickly turned on and off.

Hydroelectric plants thus advantageously permit quick responses to demands in the power market, and thus also can concentrate power production during peak or super peak hours. This advantage, however, comes with a caveat. Hydroelectric plants cannot operate 24 hours per day, seven days per week at 100% of their capacities for producing power because the impoundment (where the water is stored) that supplies water to turn the turbines and permit power generation does not have enough water to do so. Still further, there is not sufficient impoundment (storage) to save all water for use, for example, only during the summer when rates paid to plants typically are highest.

As interest in renewables has grown and as electricity markets have grown more sophisticated, this challenge has been addressed through the development of a number of tools to facilitate optimal hydropower scheduling. These tools employ a wide variety of constraints for defining the optimization problem as well as diverse mathematical approaches to solving that problem and dealing with the inherent non-linear components of the problem.

For example, one detailed model for optimal short-term operation of a cascade of hydropower stations was developed, solving the non-linear problem by using a reduced gradient method. See A. J. Wolf and P. O. Lindbergh, Optimal Short-Term Operation of a Cascade of Hydropower Stations, Transactions on Ecology and the Environment, Vol. 12 (1996), 215-221.

Another short-term electricity dispatch optimization model implemented a genetic algorithm based on a fixed unit commitment plan. See Chao Ma, Haijun Wang and Jijian Lian, Short-Term Electricity Dispatch Optimization of Ertan Hydropower Plant Based on Data by Field Tests, Journal of Renewable and Sustainable Energy 3, 063109 (2011).

Yet another model uses mixed integer linear programming (MILP) for short-term hydro scheduling to determine the optimal or near-optimal schedules for the dispatchable hydro plants in a hydro-dominant system. A commercial-grade MILP solver was used. See G. W. Chang and C. T. Su, A Practical Mixed Integer Linear Programming-Based Short-Term Hydro Scheduling, IEEE/PES Transmission and Distribution Conference and Exhibition. Oct. 6-10, 2002, pp. 1606-1610.

There exists a need for a system and method for managing power production to only occur during the highest revenue time frames (e.g., particular hours of a day). There further exists a need for a system and method for optimizing the use of fuel (e.g., water) for maximum efficiency. In addition, there exists a need for a system and method of power production that uses the least fuel while generating the most revenue.

### SUMMARY OF THE INVENTION

Unit scheduling optimization for a hydroelectric plant in a bilateral market includes: minimizing flow of water through the hydroelectric plant to meet a generation schedule, wherein integer linear programming is used for the minimizing and a set of constraints used for the minimizing includes a minimum dissolved oxygen concentration downstream of the hydroelectric plant. The minimum dissolved oxygen concentration downstream of the hydroelectric plant may be at least 6.0 milligrams per liter.

A computer-implemented method of unit scheduling optimization for a hydroelectric plant in a bilateral market includes: minimizing flow of water through the hydroelectric plant to meet a generation schedule, wherein integer linear programming is used for the minimizing and a set of constraints used for the minimizing includes a minimum dissolved oxygen concentration downstream of the hydroelectric plant. The minimum dissolved oxygen concentration downstream of the hydroelectric plant may be at least 6.0 milligrams per liter or at least 5.0 milligrams per liter. The minimum dissolved oxygen concentration downstream of the hydroelectric plant may have a daily average of 5.0 milligrams per liter with a minimum instantaneous value of not less than 4.0 milligrams per liter. The set of constraints may further include minimizing potential energy decrease of water through the hydroelectric plant per unit of electric energy produced to be between 7.2×10⁵ joules per kilowatt-hour and 3.6×10⁶ joules per kilowatt-hour. The hydroelectric plant may include at least two turbines and in some embodiments the at least two turbines may be disposed in the flow of water in a cascading arrangement.

A computer-implemented method of unit scheduling optimization for at least one hydroelectric plant in a bilateral market includes: maximizing revenue per unit flow of water through the at least one hydroelectric plant, wherein integer linear programming is used for the maximizing and a set of constraints used for the maximizing includes a minimum dissolved oxygen concentration downstream of the at least one hydroelectric plant. The maximizing may be performed to meet a generation schedule. The minimum dissolved oxygen concentration downstream of the at least one hydroelectric plant may be at least 6.0 milligrams per liter or at least 5.0 milligrams per liter. The minimum dissolved oxygen concentration downstream of the at least one hydroelectric plant may have a daily average of 5.0 milligrams per liter with a minimum instantaneous value of not less than 4.0 milligrams per liter. The at least one hydroelectric plant may include at least two turbines. In some embodiments, the at least two turbines may be disposed in a cascading arrangement.

A computer-implemented method of unit scheduling optimization for at least one hydroelectric plant in a bilateral market includes: minimizing potential energy decrease of water passing through the at least one hydroelectric plant to satisfy a generation schedule, wherein integer linear programming is used for the minimizing and a set of constraints used for the minimizing includes a minimum dissolved oxygen concentration downstream of the at least one hydroelectric plant. The set of constraints may further include minimizing potential energy decrease of the water passing through the at least one hydroelectric plant per unit of electric energy produced to be between 7.2×10⁵ joules per kilowatt-hour and 3.6×10⁶ joules per kilowatt-hour. The minimum dissolved oxygen concentration downstream of the at least one hydroelectric plant may be at least 6.0 milligrams per liter. Alternatively, the minimum dissolved oxygen concentration downstream of the at least one hydroelectric plant may be at least 5.0 milligrams per liter. In some embodiments, the minimum dissolved oxygen concentration downstream of the at least one hydroelectric plant may have a daily average of 5.0 milligrams per liter with a minimum instantaneous value of not less than 4.0 milligrams per liter. The at least one hydroelectric plant may include at least two turbines. In some embodiments, the at least two turbines may be disposed in a cascading arrangement.

A non-transitory computer-readable medium having computer readable instructions that, when executed by a processor of a computer, cause the computer to perform unit scheduling optimization for a hydroelectric plant in a bilateral market includes: minimizing a flow of water through the hydroelectric plant to meet a generation schedule, wherein integer linear programming is used for the minimizing and a set of constraints used for the minimizing includes a minimum dissolved oxygen concentration downstream of the hydroelectric plant. The minimum dissolved oxygen concentration downstream of the hydroelectric plant may be at least 6.0 milligrams per liter or alternatively at least 5.0 milligrams per liter. The minimum dissolved oxygen concentration downstream of the hydroelectric plant may have a daily average of 5.0 milligrams per liter with a minimum instantaneous value of not less than 4.0 milligrams per liter. The hydroelectric plant may include at least two turbines, and in some embodiments the at least two turbines are disposed in the flow of water in a cascading arrangement.

A system includes: a processor; memory including instructions that when executed by the processor, cause the system to perform unit scheduling optimization for a hydroelectric plant in a bilateral market including: minimizing a flow of water through the hydroelectric plant to meet a generation schedule, wherein integer linear programming is used for the minimizing and a set of constraints used for the minimizing includes a minimum dissolved oxygen concentration downstream of the hydroelectric plant. The minimum dissolved oxygen concentration downstream of the hydroelectric plant may be at least 6.0 milligrams per liter or alternatively at least 5.0 milligrams per liter. The minimum dissolved oxygen concentration downstream of the hydroelectric plant may have a daily average of 5.0 milligrams per liter with a minimum instantaneous value of not less than 4.0 milligrams per liter. In some embodiments, the hydroelectric plant comprises at least two turbines which may be disposed in the flow of water in a cascading arrangement.

### BRIEF DESCRIPTION OF THE DRAWINGS

Preferred features of the inventions are disclosed in the accompanying figures, wherein:

FIG. 1 is an image showing MATLAB's output from the optimization toolbox that resulted from running this tool.

### DETAILED DESCRIPTION OF THE PREFERRED EMBODIMENTS

Given a set of hydropower resources, those resources should be dispatched so as to maximize the revenue generated from a hydroelectric plant. Over the course of a dispatch window (which is typically 24 hours because many producers sell power in the day-ahead market), there are a number of conditions that vary including power prices, lake/impoundment levels due to natural and artificial inflows and outflows, and unit (generator) performance as a function of the water available (both quantity and level) and desired power output. In addition, operators must decide which units to turn on at what level. With so many varying conditions, the task of optimizing the scheduling of a hydroelectric facility is quite complex. For example, even if only scheduling power to the tenth of a megawatt over 24 hours, a given facility might be scheduled in no less than 2000-million-billion combinations. Deciding among those scheduling combinations is even more complex in view of the inherent non-linear nature of the problem (the power production of hydroelectric turbines and head functions are all non-linear) as well as the fact that current operation of the hydroelectric plants has temporal effects (for example, running a plant now means more water downstream later for another plant, thereby altering the characteristics of both plants' performance at that later time).

The system and method for unit scheduling optimization leverages a mixed-integer linear programming (MILP) approach such as disclosed in Bo Tong et al., An MILP Based Formulation for Short-Term Hydro Generation Scheduling With Analysis of the Linearization Effects on Solution Feasibility, IEEE Transactions on Power Systems, Vol. 28 (2013), 3588-359, which is incorporated herein by reference thereto. A MILP approach is defined by linear relationships between variables (linear) where some variables are binary (integer) and some are continuous (mixed variables). This method accurately captures the inherent binary dimension of the optimization problem (units are either on or off) and comes very near global optima without carrying too large of a computing burden (by virtue of the linear nature of the formulation). The MILP model offers a compelling method for the linearization of the non-linear components of the problem.

Another method for approximating the non-linear hydropower production function may be written as a set of linear constraints and integrated into a quadratic program, such as disclosed in Andrew Hamann and Gabriela Hug, Real-time Optimization of a Hydropower Cascade Using a Linear Modeling Approach, 2014 Power Systems Computation Conference, Aug. 18-22, 2014, which is incorporated herein by reference thereto.

A variety of algorithms may be used in the model, for example, genetic search algorithms, swarm search algorithms (such as bee or ant colony), and evolutionary population search algorithms.

An exemplary embodiment of a tool assumes that all plants are operated consistently at the same total flow rate to facilitate analysis and mirror the operators' current approach to dispatching the plants. An exemplary minimum viable product (MVP) utilizes a selected set of constraints to represent a simplified version of the problem. In both cases, the optimization is performed relative to flows rather than revenues. This is due to the bilateral-electricity market, for example in North Carolina, which requires buyers and sellers to directly contract for electricity (buyers sell direct to sellers, meaning that there is not a “market” for electricity with price curves that can be optimized against). Accordingly, brokers report to operators how much power needs to be generated during which hours of the day. From an optimization stand-point, it is desired to minimize the flows required to generate that power, so as to have more water available for generation later.

In some embodiments, unique combinations of constraints are employed in the model. In other embodiments, the effects of aeration and dissolved oxygen requirements are incorporated into the model. Furthermore, in some embodiments, Additionally, real-time performance curves are integrated into the model as reported by units (to be installed) monitoring flow into the units.

In an exemplary embodiment, hydrology optimization constraints are applied with respect to the High Rock Development located in Davie, Davidson, and Rowan counties, North Carolina on the Yadkin River and opened in 1927. The reservoir is impounded by a 936-foot-long, 101-foot-high dam that comprises (1) a 58-foor long non-overflow section, (2) a 550-foot-long gated spillway section with ten 45-foot-wide by 30-foot-high stoney gates, (3) a 178-foot-long, 125-foot-high powerhouse intake, and (4) a 150-foot-long non-overflow section. The concrete powerhouse is integral with the dam and comprises three vertical Francis turbine/generator units with a total installed capacity of 32.91 MW.

For reference, the fundamental symbols and selection symbols used in the model are as follows:

Pr: profit

δ: length of time window

T: number of time windows

J: number of reservoirs

I: number of units (usually of selected reservoir)

λ: price of power ($/MWh)

p: generation

SU: startup cost

SD: shutdown cost

V: volume

ω: inflows

Q: outflows

q: unit outflow

s: spillage

τ: water delay (between reservoirs)

l: water path # (from upstream reservoir #1 to selected reservoir)

Ω: number of upstream reservoirs

u: unit status (on [1] or off [0])

K: operating zones (of unit i)

h: head

f: function of

x: subdivision of interval (reservoir volume)

y: function evaluated at subdivision x (head)

t: selected time window

j: selected reservoir

i: selected unit

k: selected zone

m: selected subindex (for linear approximation)

The full problem constraints are as follows:

Objective Function: Maximize Profit

$$Pr = {\sum }_{t = 1}^{T} {\sum }_{j = 1}^{J} {\sum }_{i = 1}^{{I}_{j}} ( {λ}_{t} * {p}_{i , t} * δ - {SU}_{i , t} - {SD}_{i , t} )$$

The objective is to maximize profit. Profit equals price*power*time length-startup cost-shutdown cost summed over all units, reservoirs, and time frames.

Note: SU and SD are zero if status of unit hasn't changed. See constraints on SU and SD.

Water Balance:

V_{j,t}=V_{j,t-1}+ω_{j,t}^{natu}+ω_{j,t}^{up}−3600*δ*Q_{j,t}

Volume=previous volume+natural inflow+inflow from reservoir upstream−outflow times length of time window times conversion constant

Note: conversion constant is 3600 for seconds to hours. If time parameter or flow units change, conversion constant would need to change.

Water Outflows:

$${Q}_{j , t} = {s}_{j , t} + {\sum }_{i = 1}^{{I}_{j}} {q}_{i , t}$$

For each reservoir at each time outflow=spillage+sum of outfalls from each unit

Water Delay:

$${ω}_{j , t}^{up} = δ * {\sum }_{l = 1}^{{Ω}_{j}} [ ( 1 + ⌊ {τ}_{1} ⌋ - {τ}_{1} ) * {Q}_{l , t - ⌊ {τ}_{1} ⌋} + ( ⌊ {τ}_{1} ⌋ - {τ}_{1} ) * {Q}_{l , t - 1 - ⌊ {τ}_{1} ⌋} ]$$

For each reservoir at each time, inflow from upstream reservoirs=time length*sum over all upstream reservoirs ((proportion of inflow in window post floored delay)*outflow from upstream reservoir in window post floored-delay+(proportion of inflow in window post floored delay)*outflow from upstream reservoir in window pre floored-delay))

Note: equation based upon real number water delay and finding what portion of that in current window would have come from the window before the integer (rounded down) delay and what would have come from window after the integer (rounded down) delay. This is done by finding portion of time that inflows would have come from each window and multiplying that by outflow in each window.

Warning: Possible referencing of time frames outside of model may cause errors. Additional previous inflow information required to avoid this. Operator can either supply previous inflow file or the program can reference previous values. May cause issues in testing. Need to review if will assume zero for previous or throw error.

Real time updates may be included based on water delay from flow gauge upstream. This may also be possible with gauges even further upstream for day ahead optimization. This could possibly give accurate forecasting for next day optimization.

Bounds

Reservoir Volume License Limits:

Vⱼ^{lower}≤V_{j,t}≤Vⱼ^{upper}

Volume of each reservoir at each time must be between the upper and lower license levels of the reservoir.

Note: this may vary at time of year. This can be programmed automatically based on date for each system, but this will need to be adjusted between systems. Also, drought and flood could cause violations, need to automate results and output alert for these scenarios. Finally, this may be converted to lake heights because license restrictions are generally given on heights not volumes. This can be accomplished via models but may be done initially via tub assumption.

Reservoir Final Limits:

V_{j,T}^{lower}≤V_{j,T}≤V_{j,T}^{upper}

Volume of each reservoir at end of optimization must be between selected upper and lower final reservoir levels.

Note: this allows coordination with future days. Could be integrated with stochastic optimization model or smart forecasting. Currently should be based on operators intuition of where we need to take lake levels. Also worth noting should suggest bounds based on maximum upper and lower values. Else operators may try to set levels that are infeasible.

Outflow License Limits:

Qⱼ^{lower}≤Q_{j,t}≤Qⱼ^{upper}

Outflow from each reservoir in each time step must be as required between upper and lower outflow bounds

Note: These values may change based on time of year and system. This should be automated.

Additionally, outflow restrictions are usually (actually at Yadkin) total outflow for day, so constraint should be reformulated as sum. Also, drought and flood conditions influence, this should be included, automated to force to appropriate response, and alert users to occurrence of this condition.

Spillage Physical Constraint:

s_{j,t}≥0

Spillage for each unit in each time period must be zero or greater.

Note: This is a coherence constraint that ensures physical reality that spillage can only flow out of reservoir.

Unit Constraints

Dispatch Definition:

u_{i,t}∈{0,1}

Each unit in each time frame is either on (1) or off (0).

Note: To be implemented as variable bounds constraint. This is a coherence constraint.

Startup Physical Constraint:

SU_{i,t}≥0

Startup cost of each unit in each time frame is greater than or equal to zero.

Note: To be implemented as a variable bound. This is a coherence constraint to ensure physical reality that startup costs can only be positive or zero (you don't get paid to startup). This is assuming straight generation pricing not more nuanced pricing schemes where an operator may, in fact, get paid to start up. This could however be factored into startup cost. Extended operation of this nature (spinning reserve and capacity pricing) would need to be incorporated as additional revenue factor in profit equation.

Startup Cost Definition:

SU_{i,t}≥SUᵢ*(u_{i,t}−u_{i,t-1})

Startup cost of each unit it each time frame is equal to startup cost of selected unit (if unit turns on)

Note: constraint works as ui,t−ui,t−1 is 1 if unit turns on, is 0 if status stays the same, and −1 if unit turns off. However, in negative case the startup physical constraint forces value to zero since the zero equality is the intersection of the two sets. This forces startup cost of unit to be either zero (if unit does not turn on) or given startup cost (if unit does turn on) in each time window for each unit. Also, this assumes startup cost as fixed value in dollars. This could be incorporated as lost water and multiply that by current electricity price to represent actual lost value. Could also add constant value to represent capital cost on unit. This could be modified by determining the actual flow lost and passing through machine learning algorithm to develop a more precise correlation.

Shutdown Physical Constraint:

SD_{i,t}≥0

Shutdown cost of each unit in each time frame is greater than or equal to zero.

Note: To be implemented as variable bound. This is a coherence constraint to ensure physical reality that shutdown costs can only be positive or zero (you don't get paid to shutdown). This is assuming straight generation pricing not more nuanced pricing schemes where you may, in fact, get paid to shutdown. This could however be factored into shutdown cost. Extended operation of this nature would need to be incorporated as additional revenue factor in profit equation. It is worth noting that while an operator may get paid to startup, an operator almost never gets paid to shutdown.

Shutdown Cost Definition:

SD_{i,t}≥−SDᵢ*(u_{i,t}−u_{i,t-1})

Shutdown cost of each unit it each time frame is equal to shutdown cost of selected unit (if unit turns on) Note: constraint works as ui,t−ui,t−1 is 1 if unit turns off, is 0 if status stays the same, and −1 if unit turns on. However, in negative case the physical constraint forces the value to zero since the zero equality is the intersection of the two sets. This forces shutdown cost of unit to be either zero (if unit does not turn off) or given shutdown cost (if unit does turn off) in each time window for each unit. Also, this assumes shutdown cost as fixed value in dollars. This could be incorporated as lost water and multiply that by current electricity price to represent actual lost value. Could also add constant value to represent capital cost on unit. This could potentially be improved by studying actual flow lost and passing through machine learning algorithm to develop more advanced correlations to be predicted by reality. It is also quite likely that this will represent (at least currently) a prohibitive computational burden if predictively run for each correlation. It would be far simpler and effective to standardize startup procedures.

Minimum Up and Down-Time Constraints:

u_{j,t}−u_{i,t-1}=1⇒u_{i,1}=1 for l∈[t+1,t+τ̅−1]

u_{i,t}−u_{i,t-1}=−1⇒u_{i,1}=0 for l∈[t+1,t+τᵢ−1]
which is expressible linearly as:

$$∀ ( i , t ) {\sum }_{k = 1}^{min ( t + \overline{τ} - 1 , T )} {u}_{i , k} \geq \overline{τ} * ( {u}_{i , k} - {u}_{i , k - 1} )$$

$$∀ ( i , t ) {\sum }_{k = t}^{min ( t + \underline{τ} - 1 , T )} ( 1 - {u}_{i , k} ) \geq - \underline{τ} * ( {u}_{i , k} - {u}_{i , k - 1} )$$

Each unit must remain on for some number of time periods after turning on and must remain off for some number of time periods after turning off.

Restricted Operating Zone Constraints:

Zone Selection Constraint:

$${\sum }_{k = 1}^{{K}_{i}} {z}_{i , k , t} = {u}_{i , t}$$

Sum of zone indices across all zones is equal to dispatch of unit

Note: This essentially states that the unit can only operate in 1 zone if the unit is on, and zero zones if the unit is off. It is partially definitional.

Power Level Constraint:

$${\sum }_{k = 1}^{{K}_{i}} {z}_{i , k . t} * {P}_{i , k}^{lower} \leq {p}_{i , t} \leq {\sum }_{k = 1}^{{K}_{i}} {z}_{i , k , t} * {P}_{i , k}^{upper}$$

For each unit in each time interval, generation is greater than zone index times lower bound of generation for that zone. Also, generation is less than zone index times upper bound of generation for that zone.

Note: This will force z to only be true in operating zone associated with generation level as it is the only true way to satisfy this. Correspondingly, it will also force generation to be within available operating zones as otherwise this condition cannot be true. This will need to be vectorized with restrictions for each zone when implemented in code.

Zone Definition:

z_{j,k,t}∈{0,1}

This states that zone index must either be zero or one.

Note: To be implemented as variable bounds. This simply states that the unit can only operate in one zone. This is a coherence constraint.

In some embodiments, efficiency may be improved by proportional split between additive zones.

Head and Storage Constraints:

Head Level:

h_{j,t}^{f}=fⱼ(V_{j,t}^{mean})

This states that the upstream head is equal to a function of the mean volume of the upstream reservoir.

Note: This function is non-linear and is traditionally presented as a 3+degree polynomial.

For utilization in a MILP formulation, it needs to be linearized.

Warning: Utilization of the mean to calculate head on the time frame works only if the calculation of the mean is accurate (see notes on Vₘₑₐₙ) and if the utilization of the head beyond this point is linear.

Mean Volume:

V_{j,t}^{mean}=0.5*(V_{(j,t-1)}+V_{j,t})

This calculates the mean reservoir value by taking the average of the volume at the beginning and end of the window.

Warning: This method of calculating mean assumes a linear change in the volume of the reservoir over the window. The change is almost certainly non-linear; however, the change in most cases the change in head on an intra-time step basis is so small that this effect is negligible. However, in the case of an extremely shallow reservoir, very long time steps, or incredibly accurate simulations (unlikely to be achieved with this formulation of the problem or solver selection) this would be important to note.

Tail Head:

h_{j,t}^{tail}=fⱼ^{tail}(Q_{j,t})

This finds the tail head level as a function of total outflow.

Note: This function is usually approximated as a 3+degree polynomial. However, this formulation does not work in a MILP formulation and needs to be adapted.

Head Loss:

h_{i,t}^{loss}=fᵢ^{loss}(q_{i,t})

This finds the head loss of a unit as a function of flow through that unit for each time period.

Note: This function is usually approximated as a second degree polynomial. This does not work with a MILP formulation so it needs to be reformulated as a linear function.

In some embodiments, the analysis includes the head loss through the units.

Warning: This assumes a uni-linear dependence of head loss on flow through the unit. There may be some dependence on head across the unit as well, although this dependence may be small.

Head:

h_{i,t}^{loss}=fᵢ^{loss}(q_{i,t})

This states that the head across each unit on each time interval=head of the reservoir above the unit-tail head of the reservoir below the unit-head loss across the unit. Note: This is a linear formulation of net head that enables solving in an MILP framework. As discussed above, each of the terms on the right side of the equation are inherently non-linear and need to be approximated as linear for use in a MILP framework.

Unit Discharge Constraints:

0≤q_{i,t}≤qᵢ^{max}*u_{i,t}

This states that the discharge of each unit in each time window must be greater than or equal to zero and less than or equal to max flow for the unit times the dispatch index of the unit in that time frame

Note: This works as it forces flow through the unit to be zero if the unit is not dispatched, else it forces the flow to be above zero but below the maximum when u=1. This constraint may be intended to reference the physical maximum flow through the units; however, it could also be used to represent possible restricted conditions (regulatory, etc.), although this could (likely more appropriately) be accomplished with adjusted operating zones.

Past the maximum efficiency point+25% additional flow the power production function appears heavily non-linear and of a high degree; however, there is a chance that in some situations we may want to operate in these zones.

Warning: This allows zero flow in units whose dispatch is 1 (i.e. on units could have zero flow). This issue is not addressed by Tong et al., but the simplest solution is to implement a more restrictive lower bound on q:

qᵢ^{min}*u_{i,t}≤q_{i,t}≤qᵢ^{max}*u_{i,t}

Power Production Function:

p_{i,t}=Gηᵢ(h_{i,t}^{net},q_{i,t})*h_{i,t}^{net}*q_{i,t}

This states that power generated for each unit in each time period=conversion constant*efficiency of each unit (based on net head and flow across unit)*net head across unit*flow across each unit

Note: The conversion constant is dependent upon the units used for head, flow, and power. This function is traditionally modeled as a quadratic function of both net head and flow. This formulation will not work in a MILP solver, so this must be adjusted to a linear formulation for use with a MILP solver. Additionally, it has dependence on hₙₑₜ which is itself dependent on several non-linear functions that must be linearized. The solver relies on linear formulations in order to solve the entire equation. It is worth noting that the non-linear components here include efficiency, but also the multiplication of head and flow together. This function is reframed in the notes below on linearization.

Linearization of Constraints

Piecewise Linear Approximation in One Variable:

The piecewise linear approximation in one variable is performed on volume; however, the technique can be applied for linear approximation of any univariate formulation. Thus, the below need also be applied to the other nonlinear functions for a complete MILP formulation of the problem.

Subinterval Division:

Vⱼ^{lower}=x₀<x₁< . . . <x_{M}=Vⱼ^{upper}

yₘ=fⱼ(xₘ)

m=0,1,2, . . . ,M

This set of equations defines the partitioning of the function for linear approximation.

Essentially, the variable of interest (h) is approximated by subdividing the operative range of the variable it depends upon (V) by M number of points (x) such that the value of h changes nearly linearly when evaluated at these points consecutively. The values of h evaluated at selected points x are named y.

Note: The selection of M is an important consideration, as increasing M has a positive impact on accuracy, but a negative impact on computational burden. It is important to select a value for M that produces sufficient gradation in the approximation of the function; however, it also needs to be minimal to reduce computational burden.

The above formulation does not specify a regular division of x into m subintervals. These intervals can be spaced irregularly to appropriately capture nuance in the behavior of the phenomenon. This requires careful selection and tuning but promises to decouple the inverse relationship between computational performance and accuracy.

Subinterval Index Definition:

z_{m,j,t}^{V}∈{0,1}

This states that the subinterval index can only be 0 or 1 for each subinterval, reservoir, and time frame.

Note: To be implemented as variable bounds. This is a coherence constraint and coheres to the reality that the reservoir is only in or not in each subinterval. It cannot be partially in a subinterval. This, as mentioned earlier, could possibly be reformulated such that each interval is an addition to the previous interval, such that it could possibly be in a number of intervals.

Subinterval Sum Constraint:

$${\sum }_{m = 1}^{M} {z}_{m , j , t}^{V} = 1$$

This constraint states that the sum of all subinterval indexes for each reservoir and each time must be equal to 1.

Note: This is a coherence constraint. This coheres to the physical reality that the reservoir can only be in one, and must be in one, subinterval at each time.

Warning: Drought or flood could cause unexpected behavior as they stretch the applicable range of V and thus the divisions of M to be rougher. This is particularly true in custom tuned subintervals where stretching V could cause errors. Automated selection of M would address this issue. It is also worth noting that this would likely throw errors elsewhere in the program as referenced elsewhere and should trigger alerts and hard-coded behavior anyways.

Subinterval Definition Constraint:

xₘ₋₁*z_{m,j,t}^{V}≤x_{j,t}≤xₘ*z_{m,j,t}^{V}

This constraint forces z^{V}_{m,j,t} to be zero, unless x_{m,j,t} lies in the interval defined by xₘ and xₘ₋₁.

Note: Essentially this constraint merely forces z to be 1 for the subinterval in which x lies. Also, note that subindex m of x has been removed for clarity in this formulation.

Warning: This carries an implied constraint that x must be within the range presented by the full range of xₘ, else this would be unable to be satisfied and the optimization would not be able to resolve the constraints. As, at least initially, xₘ, will be implemented via regular subdivision across the full range of applicable values, so this is a sensible constraint. If x is subdivided with hand-custom tuning, this could cause inappropriate errors.

Subinterval Selection Constraint:

$${\sum }_{m = 1}^{M} {x}_{j , t} = {V}_{j , t}^{mean}$$

This constraint requires that the sum of all reservoir volumes across all subindices for each reservoir at each time is equal to the mean reservoir volume for that reservoir at that time.

Note: This forces the total approximated volume to be equal to the mean volume. As the previous equation forces x to only have some value in one interval, the two combined force x to have a value only in one interval and to have a value equal to the mean reservoir volume, which lay in the bounds of that subinterval. Also, note that subindex m of x has been removed for clarity in this formulation.

Head Evaluation Constraint:

$${h}_{j , t}^{f} = {\sum }_{m = 1}^{M} ( {z}_{m , j , t}^{V} * {y}_{m - 1} + \frac{{y}_{m} - {y}_{m - 1}}{{x}_{m} - {x}_{m - 1}} * ( {x}_{j , t} - {z}_{m , j , t}^{V} * {x}_{m - 1} ) )$$

This constraint finds the head via linear interpolation via the location of x_{j,t} in between bounds of subinterval m of x. Specifically it states that the head for each reservoir at each time t=sum over all subintervals (index of subinterval*value of head at lower bound of sub interval+slope of subinterval (found via fraction) times the relative distance of the reservoir volume from the lower volume bound of the interval. Also note, subindex m of x removed for clarity in this formulation.

Note: This constraint finds the value of head based upon linear interpolation between the bounds of the subindex that the head lies in. This formulates head as a linear function and enables utilization in a MILP formulation. The summation works as the z and x_{j,t} terms collapse to zero in all zones other than the one in which the head lies. As we do not know where these terms are (due to optimization formulation) taking the summation extracts the relevant value from the matrix via summation with the zero terms to find h.

It is worth noting that this is formulated according to m subindices for each reservoir j. It may be possible to reduce the dimensionality of later problems but compiling all operating zones into one extended vector for all units at all reservoirs.

Constraint Simplification:

The previous two constraints should not be part of the final formulation as everywhere hf and Vₘₑₐₙ can simply be replaced by the equalities. Implementation of these constraints as is could be considered; however, they would have adverse effects on performance so they should be implemented in any operational implementation.

Piecewise Linear Approximation in Two Variables:

This approximation is shown for the power production function. This is the only non-linear multivariate equation in this formulation; however, this technique can be applied to other equations as necessary. The hydropower production function is a function of three variables—flow, head, and efficiency (which in turn depends on flow and head). This complex function is interpolated linearly as shown below. In implementation, this is done relative to the power production surface for each unit.

Head Subdivision:

h^{min}=h₀<h₁< . . . <h_{N}=h^{max}

This equation subdivides the operating region of head into N subintervals between the minimum and maximum head across the unit.

Note: The selection of N is an important consideration, as increasing N has a positive impact on accuracy, but a negative impact on computational burden. It is important to select a value for N that produces sufficient gradation in the approximation of the function; however, it also needs to be minimal to reduce computational burden.

The above formulation does not specify a regular division of h into n subintervals. These intervals can be spaced irregularly to appropriately capture nuance in the behavior of the phenomenon. This requires careful selection and tuning but promises to decouple the inverse relationship between computational performance and accuracy.

Warning: Determination of hₘᵢₙ and hₘₐₓ must be intentional to avoid issues with illogical, or out of range results. This relates to license restrictions, unit operating constraints, and deviation of field conditions. Additionally, drought and flood conditions can cause parameters to exceed these bounds and possibly introduce unexpected behavior. Features must be incorporates as noted elsewhere. This underscores the nature of this program as a short-term optimization under the longer-term guidance of operators.

Hydropower Production Approximation:

p=g(h,q)≈gₙ(q)=g(hₙ^{rep},q)

This divides the hydropower production function into a family of curves gₙ that are univariate over the given range of heads n and that are essentially g evaluated at h_{rep,n} in that region.

Note: This separates one variable out of the equation and reduces p to being non-linear in one dimension.

As noted above, the division of g into n subintervals has substantial impacts upon performance and computational demands. Preferably, this process should be automated to ensure a certain degree of precision under certain resource constraints. Initial implementation will use a regular subdivision to achieve reasonable performance. Additionally, a similar process applies to the selection of h_{rep,n}. Initially, this will simply be selected as the middle of each region. Ultimately, it should be the true mean of each subinterval as based upon integrating the function over the subinterval and dividing by the subinterval length. This becomes more important as smart subintervals are selected and does not represent a problem in an initial implementation.

Flow Piecewise Approximation:

q^{lower}=q_{0,n}<q_{1,n}< . . . <q_{M}_{ₙ}_{,n}=q^{upper}

g_{m,n}=gₙ(q_{m,n})

m=0,1,2, . . . Mₙ

This division is similar to the one dimensional case, and represents a division of flow rates between upper and lower bounds over M steps. Reference notes on one variable linearization for additional details. The primary difference is that this occurs n times for each subinterval created by the head subdivision.

In initial implementation, this division should be conducted equally over all subintervals, regularly within each subinterval, and regularly over all subintervals. This will greatly simplify implementation. As noted elsewhere, in this case the selection of M and the intervals associated with it are important. In some embodiments, the bounds could be adjusted for each N, the sampling can vary over each subinterval M, and the sampling can vary between subintervals. This offers important opportunities for optimization of accuracy and cost but is a non-trivial automation. Preferably, this may be optimized to capture important nuances in the behavior of each curve while minimizing sampling of more-linear portions of curves.

Warning: As mentioned above, and with all bounded constraints, care must be taken that bounds correspond to physical, operational, and regulatory constraints, and behave correctly in the case of extreme hydrological conditions.

Index Constraints of Water Head:

These constraints are similar to constraints for linearization in one variable. Therefore, detailed notes are not presented below. Refer to notes on similar constraint for additional detail. It is important to note that the primary difference here is that this approximation is partnered with another (described below) to approximate a multi-variate function.

$${z}_{n}^{( 1 )} ∈ \{ 0 , 1 \}$$

$${\sum }_{n = 1}^{N} {z}_{n}^{( 1 )} = 1$$

$${h}_{n - 1}^{upper} * {z}_{n}^{( 1 )} \leq {h}_{n} \leq {h}_{n}^{upper} * {z}_{n}^{( 1 )}$$

$${\sum }_{n = 1}^{N} {h}_{n} = h$$

While Tong et. al. only present this linearization for a single set of heads, it is desired to provide an implementation for a range of heads, and also a range of heads for each unit, of each reservoir, at each time, for a range of flows. In one embodiment, the entire set of heads is implemented as one long strand. While this may present issues with the bounds on hₙ. such issues may be circumnavigated with additional subindex variables implemented as selection factors in addition to zₙ. The problem also can be implemented in five-dimensions, but this presents issues with respect to readability. In addition, this multivariate function may be linearized on each pass through a separate linearizing function, although this may have substantial negative impacts on performance. Additional analysis, research, review of best practices, and testing is required to address this issue. Possible implementation for one unit may be advised for a test implementation to keep these constraints three dimensional (time, flow, and head).

Linear Approximation of Hydropower Output:

$${z}_{m , n}^{( 2 )} ∈ \{ 0 , 1 \} , n = 1 , 2 , … , N and m = 1 , 2 , … , {M}_{n}$$

$${\sum }_{m = 1}^{{M}_{n}} {z}_{m , n}^{( 2 )} = {z}_{n}^{( 1 )} , n = 1 , 2 , … , N$$

$${\overline{q}}_{m , n - 1} {z}_{m , n}^{( 2 )} \leq {q}_{m , n} \leq {\overline{q}}_{m , n} {z}_{m , n}^{( 2 )} , \\ n = 1 , … , N and m = 1 , … , {M}_{n}$$

$${\sum }_{n = 1}^{N} {\sum }_{m = 1}^{{M}_{n}} {q}_{m , n} = q$$

$$p = {\sum }_{n = 1}^{N} {\sum }_{m = 1}^{{M}_{n}} ( {z}_{m , n}^{( 2 )} {g}_{m - 1 , n} + \frac{{g}_{m , n} - {g}_{m - 1 , n}}{{\overline{q}}_{m , n} - {\overline{q}}_{m - 1 , n}} \cdot ( {q}_{m , n} - {z}_{m , n {\overline{q}}_{m - 1 , n}}^{( 2 )} ) )$$

The nonlinear function for power is bivariate, depending on both water discharge and the net water head. Here, a two-dimensional index variable, z_{m,n}, is used to generate a linear approximation. These constraints are of similar form to those discussed previously, where only one q_{m,n} and z_{m,n} are nonzero so that the summand in used to calculate power is only nonzero for a single pair. These constraints interpolate with respect to flow but not head—why that choice was made is unclear, and it should be possible to interpolate in both dimensions.

Note: Since the only variable dependent on head is power, one could eliminate head as a variable and instead linearize power with respect to three variables (discharge, total output, and volume) at once using a three-dimensional index variable.

In another exemplary embodiment, hydrology optimization constraints are applied with respect to the High Rock Development. For reference, the fundamental symbols and selection symbols used in the model are as follows:

δ: length of time window

T: number of time windows

J: number of reservoirs

I: number of units at each reservoir nonexistent units have (negative efficiency)

p: generation (MWh)

SU: startup cost ($)

SD: shutdown cost ($)

V: volume (measured between time intervals)

Q: outflows

q: unit outflow

s: spillage

u: unit status (binary)

z: selection variable (binary)

w: selection variable (NOT binary)

h: head

x: subdivision of interval

y: function evaluated at subdivision x

t: selected time window

j: selected reservoir

i: selected unit

m, n: selected subindex (for linear approximation)

Objective:

$$minimize ( {\sum }_{t , j} {Q}_{j , t} )$$

The goal is to minimize the total flow through all dams. These flows could be weighted based on which dam they pass through, though this would probably only be necessary for very short-term use. A similar approach would be to maximize the final total volume of the reservoirs.

Target Power:

$${p}_{t}^{target} \leq {\sum }_{j , i} {p}_{j , i , t}$$

This simply states that for all time periods, the power generated by all units in all reservoirs must sum to the target power.

Water Balance:

V_{j,1}=Vⱼ^{start}

V_{j,t}=V_{j,t-1}+3600*δ*(Q_{j-1,t}−Q_{j,t}) for j≥2,t≥2

V_{1,t}=V_{1,t-1}+3600*δ*(Qᵣ^{upstream}−Q_{1,t}) for t≥2

Volume=previous volume+(inflow from reservoir upstream−outflow) times length of time window times conversion constant

It is assumed that the travel time for water between dams is negligible.

Water Outflows:

$${Q}_{j , t} = {s}_{j , t} + {\sum }_{i = 1}^{{I}_{j}} ( {q}_{j , i , t} + {SU}_{j , i , t} + {SD}_{j , i , t} )$$

For each reservoir at each time, the total outflow is the sum of unit discharges plus shut down and start up losses plus spillage.

Bounds

Reservoir Volume License Limits:

Vⱼ^{lower}≤V_{j,t}≤Vⱼ^{upper}

Outflow License Limits:

Qⱼ^{lower}≤Q_{j,t}≤Qᵢ^{upper}

Spillage Physical Constraint:

s_{j,t}≥0

Unit Constraints

Startup Physical Constraint:

SU_{i,t}≥0

Startup Cost Definition:

SU_{j,i,t}≥SU_{j,i}*(u_{j,i,t}−u_{j,i,t-1}) for t≥2

The start up cost is incurred when the unit was off and turns on, i.e. when

u_{j,i,t}=1, u_{j,i,t-1}=0.

Shutdown Physical Constraint:

SD_{j,i,t}≥0

Shutdown Cost Definition:

SD_{j,i,t}≥SD_{j,i}*(u_{j,i,t-1}−u_{j,i,t})

The shutdown cost is incurred when the unit was on and turns off, i.e. when

u_{j,i,t}=0, u_{j,i,t}=1.

Head and Storage Constraints:

Head Level:

h_{j,t}^{f}=fⱼ(V_{j,t}^{mean})

Upstream head is a nonlinear function of volume, and must be linearized.

Tail Head:

h_{j,t}^{tail}=fⱼ^{tail}(Q_{j,t})

Tail head is a nonlinear function of outflow, and must be linearized.

Head Loss:

h_{i,r}^{loss}=fᵢ^{loss}(q_{i,t})

Head loss is a nonlinear function of unit discharge, and must be linearized.

Head:

h_{j,i,t}^{net}=h_{j,t}^{f}−h_{j,t}^{tail}−h_{j,i,t}^{loss}

The net head is the difference between the upstream head and tail head with some loss in the unit.

Unit Discharge Constraints:

q_{j,i,t}^{min}*u_{j,i,t}≤q_{j,i,t}≤q_{j,i}^{max}*u_{j,i,t}

When off, each unit has 0 outflow. When on, they have no more than their maximum outflow and no less than their minimum. This also forces the unit to be off when it has zero outflow.

Power Production Function:

p_{i,t}=Gηᵢ(h_{i,t}^{net},q_{i,t})*h_{i,t}^{net}*q_{i,t}

The power generated by a unit is proportional to efficiency, head, and flow through the unit. This is nonlinear in two variables, and must be linearized.

Linearization of Constraints

Piecewise Linear Approximation in One Variable:

This process is nearly identical for the three univariate functions used to calculate head, so only the first set of constraints is presented.

Subinterval Division:

Vⱼ^{lower}=x₀<x₁< . . . <x_{M}=Vⱼ^{upper}

yₘ=fⱼ(xₘ)

m=0,1,2, . . . ,M

This establishes a set of constants used to approximate the function. x gives a sampling of the volumes, and y is the corresponding sampling of head.

Subinterval Sum Constraint:

$${\sum }_{m = 1}^{M} {z}_{m , j , t}^{V} = 1$$

This forces one and only one z to be 1.

Subinterval Definition Constraint:

xₘ₋₁*z_{m,j,t}^{V}≤w_{m,j,t}≤xₘ*z_{m,j,t}^{V}

This makes z 1 for the interval in which w lies. It also forces w to be nonzero at only one index.

Subinterval Selection Constraint:

$${\sum }_{m = 1}^{M} {w}_{m , j , t} = .5 * ( {V}_{( j , t - 1 )} + {V}_{j , t} )$$

The RHS is just Vₘₑₐₙ, so this states that w is the average value of volume in each time interval only at the index (m) where z is one. It is zero elsewhere due to the subinterval definition constraint.

Head Evaluation Constraint:

$${h}_{j , t}^{f} = {\sum }_{m = 1}^{M} ( {z}_{m , j , t}^{V} * {y}_{m - 1} + \frac{{y}_{m} - {y}_{m - 1}}{{x}_{m} - {x}_{m - 1}} * ( {w}_{j , t} - {z}_{m , j , t}^{V} * {x}_{m - 1} ) )$$

The summand is zero except for one value of m in each time interval. At this value, z is one, making this a simple linear interpolation on the interval xₘ₋₁ to xₘ.

Piecewise Linear Approximation in Two Variables:

Head Subdivision:

h^{min}=xₙ^{h}<x₁^{h}< . . . <x_{N}^{h}=h^{max}

xₕ is a sampling of head.

Hydropower Production Approximation:

p=g(h,q)≈gₙ(q)=g(hₙ^{rep},q)

This does not provide an explicit constraint, but is included for clarity. The bivariate function is divided into several univariate functions with respect to unit discharge, each of which holds head constant.

Flow Piecewise Approximation:

q^{lower}=x_{0,n}^{q}<x_{1,n}^{q}< . . . <x_{M}_{ₙ}_{,n}^{q}=q^{upper}

y_{m,n}^{hq}=gₙ(x_{m,n}^{q})=g(hₙ^{rep},x_{m,n}^{q})

m=0,1,2, . . . Mₙ

This divides flow rates for each head subinterval and gives the value y^{hq} of power in each interval.

Index Constraints of Water Head:

$${z}_{n}^{h} ∈ \{ 0 , 1 \}$$

$${\sum }_{n = 1}^{N} {z}_{n}^{h} = 1$$

$${h}_{n - 1}^{upper} * {z}_{n}^{h} \leq {w}_{n}^{h} \leq {h}_{n}^{upper} * {z}_{n}^{h}$$

$${\sum }_{n = 1}^{N} {w}_{n}^{h} = h$$

These are similar to the linearization scheme for one dimensional functions—they are expanded into another variable below.

Linear Approximation of Hydropower Output:

$${z}_{m , n}^{h , q} ∈ \{ 0 , 1 \} , n = 1 , 2 , … , N and m = 1 , 2 , … , {M}_{n}$$

$${\sum }_{m = 1}^{{M}_{n}} {z}_{m , n}^{h , q} = {z}_{n}^{h} , n = 1 , 2 , … , N$$

$${\overline{q}}_{m , n - 1} {z}_{m , n}^{h , q} \leq {q}_{m , n} \leq {\overline{q}}_{m , n} {z}_{m , n}^{h , q} , \\ n = 1 , … , N and m = 1 , … , {M}_{n}$$

$${\sum }_{n = 1}^{N} {\sum }_{m = 1}^{{M}_{n}} {q}_{m , n} = q$$

$$p = {\sum }_{n = 1}^{N} {\sum }_{m = 1}^{{M}_{n}} ( {z}_{m , n}^{h , q} {y}_{m - 1 , n}^{h , q} + \frac{{y}_{m , n}^{h , q} - {y}_{m - 1 , n}^{h , q}}{{\overline{q}}_{m , n} - {\overline{q}}_{m - 1 , n}} \cdot ( {q}_{m , n} - {z}_{m , n {\overline{q}}_{m - 1 , n}}^{h , q} ) )$$

Here the linearization is expanded into another variable, unit outflow. Importantly, these equations lack several indexing variables for readability—each of the variables utilized above are specific to a reservoir, a unit at that reservoir, and a time period. Power is actually three dimensional, while z, y, and q are five dimensional.

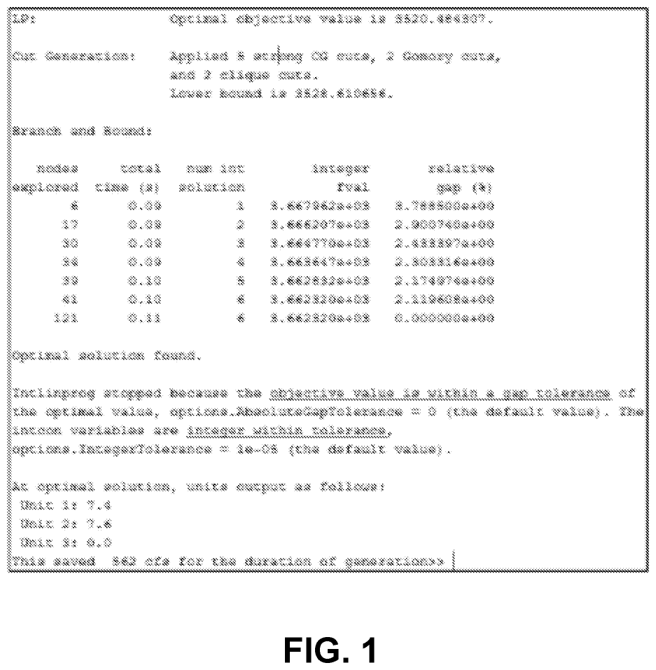

In Yadkin, water is currently dispatched between dams according to water balance with balanced units. However, more efficient outcomes may be achieved by varying reservoir height and unit loading. Over 2000 million billion schedule combinations are available for each generation window, and thus use of a generation optimization algorithm permits identification of a mathematically optimal generation schedule. The algorithm may apply advanced mixed-integer linear programming (MILP) to efficiently locate optimal generation outcomes. MILP optimizes variables on constrained sets of values to match real-world plant operation. The completed unit commitment tool preferably searches possible unit loadings for a given plant to locate the optimal split across the units for maximum efficiency. Preferably, dispatch optimization may improve overall generation efficiency by 2%. Optimization for a 15 MW output at High Rock is shown in FIG. 1.

As shown in FIG. 1, all of the output is from MATLAB's library up until the unit outputs. It is based on well-known algorithms that are common across MILP libraries. First, the program optimizes as a linear problem (LP), relaxing all integer constraints. This can be done quickly (in polynomial time) and bounds the optimal value. Cut generation is the process of adding additional constraints to the problem to restrict solutions to be closer to integers, making the algorithm slightly faster. Branch and Bound is the main algorithm. First, the problem is solved as a LP, then all integer variables are checked to ensure they are within the tolerance of an integer. If they are not, then one of the integer variables failing the test is chosen, and the problem is split into two parts that are solved separately. For example, if x must be an integer, but the solution to the LP yields x=2.4, then two problems would be solved, one with x≤2 and one with x≥3 as additional constraints. This process is repeated recursively and stops when either all integer variables are within the tolerance or the objective function evaluates as worse than an already found, integer feasible solution.

Nodes explored indicates the number of linear problems solved. Total time is in seconds. Num int solution is the number of feasible integer solutions found so far. Integer fval is the best valid objective value found. Relative gap is the percentage difference between the best objective value across integer feasible points that have been found and the bound on the objective value from a relaxed linear problem.

In this case, the stop condition is reached because the relaxed objective and the integer objective converge, indicating the solution found is known to be optimal.

The final output is the optimal solution for the dam being optimized, given as a dispatch to each unit, in MW. This is compared against historical data to estimate the amount of water saved by applying the optimized strategy.

In summary, to optimize, fuel should be utilized at the most efficient points of the units (generators) (head, flow and power—three-dimensional surface). It is desired to operate at the peak point of the three-dimensional efficiency curve all the time if possible. It is desired to do that at the highest price times. But a hydroelectric facility cannot simply operate at that optimal point all the time because the highest efficiency point is not the highest revenue point. Sometimes, it is better to generate more power at a lower efficiency because that results in the highest revenue, or perhaps because there is no more water storage available (e.g., the impoundment is “full”) so the water would be wasted anyway and thus the plant might as well generate the power.

The cascade point refers to the fact that a dam generates more power more efficiently when there is a greater net head difference across the project (an individual dam).

The higher the head, the more power and usually the higher the efficiency.

In a cascade, it is desired to be strategic in the manner in which water is passed in order to maximize efficiency.

Thus, at any given dam, it is desired to maximum head difference. It also is desired that there is zero water on the downstream side, while high water on the upstream side.

In a hypothetical ideal operation, all water starts upstream of the first dam which gives the maximum head difference across the first dam. Then, the hydroelectric plant of the first dam is run until that difference decreases to some number. At some point, when the water level gets to a certain number upstream of the second dam, the net head at the second dam has increased to a number that is favorable and then the hydroelectric plant of the second dam is run. And so on.

However, anywhere you maximize the head difference, you pay a price somewhere else.

So in a situation of two dams with differing outputs, especially a smaller output upstream of a larger output, it is desired to have maximum head difference across the largest plant during the highest revenue hours. So accordingly, more power is generated at the smaller plant during non-peak revenue hours in order to have maximum head difference at the largest plant that is the dam downstream (below).

But the upstream plant may have higher flow than the downstream plant (due to different operating characteristics such as different turbines, different hydrology (such as the water coming out of upstream dam splits to feed two different lakes) and so water movement across dams may differ in timing, such that it may not be a simple matter of assuming that all water passing through the upstream dam is available at the downstream dam.

In the example of the Yadkin dams, there are four lakes. The largest lake is at the highest elevation and it has about ten days of storage (meaning it could run continuously for ten days if the lake was full—in the licensed range of lake level permitted by FERC-without any water coming in). In contrast, the smallest lake has only three hours of storage. Thus, there is an 80× difference between the largest lake and the smallest lake. The largest lake is above plant A, which is average in terms of head, flow, power, and number of units of the four plants. Plant B has the most flow. Plant C has the highest head and has the most power-producing capability (plant C is rated at 110 MW, as compared to plants A, B, and D). Plant D is disposed at the smallest lake and is otherwise average.

The challenge is to determine when an operator moves what water through which units to maximize revenue. This is peculiar in North Carolina, for example, because it is a bilateral (closed) market, so you have to agree to sell power to someone at a certain price. And so this means that the buyer wants a fixed amount of power for a fixed number of hours. For example, an operator may purchase 145 MW for seven hours. Whereas in an open market, a plant might instead generate 35 MW, 42 MW, 64 MW, 206 MW, 204 MW, 208 MW, and 22 MW over the same seven hours because there are no deals in place (in other words, a plant just sells power into the market at the then-current price).

A bilateral market is peculiar because the code is not written to maximize revenue, but instead is written to minimize fuel used. In contrast, in a free market, the code is written to maximize revenue.

In some embodiments, the hydroelectric plant operator coordinates with the broker(s) to assist in bidding (e.g., in determining which bids have the greatest value rather than the greatest revenue). The tool evaluates bids against each other and writes a schedule to accept bids that have the most value. One bidder for example may find that a buyer #1 will purchase 8 hours at price X, while another buyer #2 will purchase 6 hours at price Y. Moreover, an operator may engage in “wheeling through,” e.g., paying someone to transmit the power to an open market and sell it there (for example, an operator could pay to transmit the power to another geographic region).

In some embodiments, the tool evaluates all bids that are received and builds the best schedule for the day accounting for prices, timing, fuel used, and how much fuel is desired to be used. The computational challenge is that in order to evaluate bids, a response must be provided very quickly (within minutes). For example, a buyer may be willing to pay $40 per megawatt-hour for six hours for 185 megawatts (so willing to purchase 185×6 megawatt-hours). The tool is used to evaluate bids and then dispatch the units (turn them on and at one level) maximally efficiently.

In reality, operations do not occur in a binary manner; whole plants are not turned on or off at maximum capacity throughout a day. Instead, outputs are incrementally changed (e.g., how much flow you are allowing through) and generation occurs to maximize efficiency and revenue as prices change.

In some embodiments, forecasts with risk are incorporated into the optimization model. For instance if a forecast shows with 85% certainty that it will flood in 14 days, a decision is made concerning to what degree the lakes/impoundments are drawn down. If that forecast is correct, it may be desirable to empty the lakes/impoundment in 14 days when the flood happens. The risk factor changes each day; this is a stochastic phenomenon.

Any party may produce power, but there are a limited number of buyers of power in the bilateral market. The broker sits in the middle of the transaction, trying to match a buyer with a seller but working for the seller and taking a commission.

There are a limited number of intermediaries, who are the utilities. In wholesale generation, power must be sold through a utility. A hydroelectric plant may be a wholesale generator; in other words, the plant may not be able to sell to customers within the state in which it is located, but instead only to utilities (although the plant could sell to out-of-state customers, while paying to have the power transmitted to them). A broker helps make the deal by calling the utilities (there are only six of them) who will buy power. The broker coordinates with the dispatcher to know how much water the dam has (e.g., plenty) available to provide the next day, and so broker will call the buyer and find out how much they want to buy and when, and then tells the hydroelectric plant operator how much business they received for the next day. This is a closed/bilateral market because of the direct agreement between the buyer and the seller.

In some embodiments, the integer linear programming (intlinprog) solver in Matlab is used and is provided with an objective (minimize flow), a set of constraints, and a set of variables (what the solver can adjust). An example constraint is reservoir minimum and maximum levels as set by FERC. An example variable is unit output (e.g., output from a particular combination of turbine and generator). The solver preferably solves an integer linear programming problem. Although the intlinprog solver in Matlab is used in the exemplary embodiment, alternate numerical solvers (linear) may be used such as coin-orbranchandcut (an open source solver) or scip (solving constraint integer programs) or gopk or gurobi (a Matlab analog). Moreover, although the Matlab programming language is used in the exemplary embodiment, other languages may be used such as Python, C++, or JAVA.

The algorithm employed in the optimization may be particularly suited for a bilateral market. There are two primary ways to do this. First, the optimization may be implemented as a tool for evaluating bids. Second, the optimization may be designed to minimize flow rather than maximize revenue, because of the fixed agreements. In other words, the solver seeks to optimally allocate fuel to meet demands.

In some embodiments, the optimization may incorporate constraints involving meeting dissolved oxygen (DO) requirements. The optimization may seek to keep DO concentrations at a certain level, and must determine which units are dispatched at what levels to maximize revenue while remaining complaint with DO requirements (such as set by the state). The optimization also may seek to dispatch those units in the most profitable and efficient manner.

For example, optimization may incorporate constraints in order to address concerns about the potential ecological influence of dams, specifically their potential impact on water quality. The hypolimnion may become particularly oxygen-deprived, with the concentration of dissolved oxygen even potentially decreasing to a level as low as 1 milligram per liter (which is 1 part per million (ppm)), and this may present challenges to hydropower operators, for example, if the desired dissolved oxygen concentration downstream of the hydroelectric plant is at least 6.0 milligrams per liter (6 ppm). For example, Title 15A (Environmental Quality) of the North Carolina Administrative Code (NCAC) assigns classifications and water quality standards to surface waters and wetlands in the state. “Class C” freshwaters are defined in 15A NCAC 02B.0101(c)(1) as “freshwaters protected for secondary recreation, fishing, aquatic life including propagation and survival, and wildlife. All freshwaters shall be classified to protect these uses at a minimum.” As for “fresh surface water standards for Class C waters,” 15A NCAC 02B.0211(6) requires: “Dissolved oxygen: not less than 6.0 mg/l for trout waters; for non-trout waters, not less than a daily average of 5.0 mg/l with a minimum instantaneous value of not less than 4.0 mg/l; swamp waters, lake coves, or backwaters, and lake bottom waters may have lower values if caused by natural conditions.”

By using optimization, operators of hydroelectric plants may proactively mitigate any potential impacts “below the dam,” such as in the tailwater immediately downstream of the dam.

In some embodiments, real-time efficiency curves may be integrated into the model. Usually, efficiency surfaces are developed from the index tests when a unit is commissioned (showing how the unit works at particular flows and heads). However, if flow monitoring is installed on the units themselves (e.g., ultrasonic flow meters), then it is possible to know, minute to minute, precisely the behavior of each unit and that data can be used to update the efficiency curves to generate maximally efficient dispatch based on what's actually happening and not what is predicted to be happening in view of data generated when commissioning occurred.

In some embodiments, two separate optimizations are run. First, an optimization is run for every feasible mode of operation of the plant (for every head water and tailwater level, every power output of the unit). In other words, a first optimization occurs, so when the operator knows the headwater and tailwater levels and wants to run two units to generate a certain amount of power, the operator knows for every combination what the optimal schedule will be, and runs it once for every plant so as to generate a matrix: for a particular head level, tail level, and generation, the matrix provides the values of power to set the units to produce. Such a matrix represents a very large database. Thus, a second optimization may then be run to search the matrix while doing the optimization.

In some embodiments, one optimization is run within a plant (for example, to split a power generation task between units). Another optimization may be run between plants. Such a design may dramatically reduce computational intensity and thus increase accuracy and features.

It should be noted that each generator generates power slightly differently. So, it is not best to distribute power generation evenly, e.g., need to generate 30 MW so give each of three units 10 MW of responsibility. Instead, it is more likely that one unit should be given 10.3 MW responsibility, another one given 10.1 MW responsibility, and a third one given 9.7 MW responsibility.

In some embodiments, the models disclosed herein for hydroelectric power instead may be applied to steam generation or generating heat.

The embodiments herein optionally may be presented as including individual functional blocks including functional blocks comprising devices, device components, steps or routines in a method embodied in software, or combinations of hardware and software.

In some embodiments the computer-readable storage devices, mediums, and memories for use in connection with the embodiments herein may include a cable or wireless signal containing a bit stream and the like. However, when mentioned, non-transitory computer-readable storage media expressly exclude media such as energy, carrier signals, electromagnetic waves, and signals per se.

Methods in accordance with the embodiments herein may be implemented using computer-executable instructions that are stored or otherwise available from computer readable media. Such instructions may comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods in accordance with the embodiments herein include, but are not limited to, magnetic or optical disks, flash memory, USB devices provided with non-volatile memory, and networked storage devices.

Devices implementing methods in accordance with the embodiments herein may comprise hardware, firmware and/or software, and may take any of a variety of form factors including, but not limited to, laptops, smart phones, small form factor personal computers, personal digital assistants, rackmount devices, and standalone devices. Functionality described herein also can be embodied in peripherals or add-in cards and may be implemented on a circuit board among different chips or different processes executing in a single device, for example.

The instructions, media for conveying such instructions, computing resources for executing them, and other structures for supporting such computing resources are means for providing the functions described herein.

Although a variety of examples and other information was used to explain aspects within the scope of the appended claims, no limitation of the claims should be implied based on particular features or arrangements in such examples, as one of ordinary skill would be able to use these examples to derive a wide variety of implementations.

Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

While various descriptions of the inventions are described above, it should be understood that the various features can be used singly or in any combination thereof. Therefore, the inventions are not to be limited to only the specifically preferred embodiments depicted or otherwise described herein.

Further, it should be understood that variations and modifications within the spirit and scope of the inventions may occur to those skilled in the art to which the inventions pertain. Accordingly, all expedient modifications readily attainable by one versed in the art from the disclosure set forth herein that are within the scope and spirit of the inventions are to be included as further embodiments of the inventions. The scope of the inventions is accordingly defined as set forth in the appended claims.

What is claimed is:

1. A computer-implemented method of unit scheduling optimization for a hydroelectric plant in a bilateral market comprising:
minimizing flow of water through the hydroelectric plant to meet a generation schedule, wherein integer linear programming is used for the minimizing and a set of constraints used for the minimizing comprises a minimum dissolved oxygen concentration downstream of the hydroelectric plant.

2. The method of claim 1, wherein the minimum dissolved oxygen concentration downstream of the hydroelectric plant is at least 6.0 milligrams per liter.

3. The method of claim 1, wherein the minimum dissolved oxygen concentration downstream of the hydroelectric plant is at least 5.0 milligrams per liter.

4. The method of claim 1, wherein the minimum dissolved oxygen concentration downstream of the hydroelectric plant has a daily average of 5.0 milligrams per liter with a minimum instantaneous value of not less than 4.0 milligrams per liter.

5. The method of claim 1, wherein the set of constraints further comprises minimizing potential energy decrease of water through the hydroelectric plant per unit of electric energy produced to be between 7.2×10⁵ joules per kilowatt-hour and 3.6×10⁶ joules per kilowatt-hour.

6. The method of claim 1, wherein the hydroelectric plant comprises at least two turbines.

7. The method of claim 6, wherein the at least two turbines are disposed in the flow of water in a cascading arrangement.

8. A computer-implemented method of unit scheduling optimization for at least one hydroelectric plant in a bilateral market comprising:
maximizing revenue per unit flow of water through the at least one hydroelectric plant, wherein integer linear programming is used for the maximizing and a set of constraints used for the maximizing comprises a minimum dissolved oxygen concentration downstream of the at least one hydroelectric plant.

9. The method of claim 8, wherein the maximizing is performed to meet a generation schedule.

10. The method of claim 8, wherein the minimum dissolved oxygen concentration downstream of the at least one hydroelectric plant is at least 6.0 milligrams per liter.

11. The method of claim 8, wherein the minimum dissolved oxygen concentration downstream of the at least one hydroelectric plant is at least 5.0 milligrams per liter.

12. The method of claim 8, wherein the minimum dissolved oxygen concentration downstream of the at least one hydroelectric plant has a daily average of 5.0 milligrams per liter with a minimum instantaneous value of not less than 4.0 milligrams per liter.

13. The method of claim 8, wherein the at least one hydroelectric plant comprises at least two turbines.

14. The method of claim 13, wherein the at least two turbines are disposed in a cascading arrangement.

15. A computer-implemented method of unit scheduling optimization for at least one hydroelectric plant in a bilateral market comprising:
minimizing potential energy decrease of water passing through the at least one hydroelectric plant to satisfy a generation schedule, wherein integer linear programming is used for the minimizing and a set of constraints used for the minimizing comprises a minimum dissolved oxygen concentration downstream of the at least one hydroelectric plant.

16. The method of claim 15, wherein the set of constraints further comprises minimizing potential energy decrease of the water passing through the at least one hydroelectric plant per unit of electric energy produced to be between 7.2×10⁵ joules per kilowatt-hour and 3.6×10⁶ joules per kilowatt-hour.

17. The method of claim 15, wherein the minimum dissolved oxygen concentration downstream of the at least one hydroelectric plant is at least 6.0 milligrams per liter.

18. The method of claim 15, wherein the minimum dissolved oxygen concentration downstream of the at least one hydroelectric plant is at least 5.0 milligrams per liter.

19. The method of claim 15, wherein the minimum dissolved oxygen concentration downstream of the at least one hydroelectric plant has a daily average of 5.0 milligrams per liter with a minimum instantaneous value of not less than 4.0 milligrams per liter.

20. The method of claim 15, wherein the at least one hydroelectric plant comprises at least two turbines.

21. The method of claim 20, wherein the at least two turbines are disposed in a cascading arrangement.

22. A non-transitory computer-readable medium having computer readable instructions that, when executed by a processor of a computer, cause the computer to perform unit scheduling optimization for a hydroelectric plant in a bilateral market comprising:
minimizing a flow of water through the hydroelectric plant to meet a generation schedule, wherein integer linear programming is used for the minimizing and a set of constraints used for the minimizing comprises a minimum dissolved oxygen concentration downstream of the hydroelectric plant.

23. The non-transitory computer-readable medium of claim 22, wherein the minimum dissolved oxygen concentration downstream of the hydroelectric plant is at least 6.0 milligrams per liter.

24. The non-transitory computer-readable medium of claim 22, wherein the minimum dissolved oxygen concentration downstream of the hydroelectric plant is at least 5.0 milligrams per liter.

25. The non-transitory computer-readable medium of claim 22, wherein the minimum dissolved oxygen concentration downstream of the hydroelectric plant has a daily average of 5.0 milligrams per liter with a minimum instantaneous value of not less than 4.0 milligrams per liter.

26. The method of claim 22, wherein the hydroelectric plant comprises at least two turbines.

27. The method of claim 26, wherein the at least two turbines are disposed in the flow of water in a cascading arrangement.

28. A system comprising: a processor; memory including instructions that when executed by the processor, cause the system to perform unit scheduling optimization for a hydroelectric plant in a bilateral market comprising:
minimizing a flow of water through the hydroelectric plant to meet a generation schedule, wherein integer linear programming is used for the minimizing and a set of constraints used for the minimizing comprises a minimum dissolved oxygen concentration downstream of the hydroelectric plant.

29. The system of claim 28, wherein the minimum dissolved oxygen concentration downstream of the hydroelectric plant is at least 6.0 milligrams per liter.

30. The system of claim 28, wherein the minimum dissolved oxygen concentration downstream of the hydroelectric plant is at least 5.0 milligrams per liter.

31. The system of claim 28, wherein the minimum dissolved oxygen concentration downstream of the hydroelectric plant has a daily average of 5.0 milligrams per liter with a minimum instantaneous value of not less than 4.0 milligrams per liter.

32. The method of claim 28, wherein the hydroelectric plant comprises at least two turbines.

33. The method of claim 32, wherein the at least two turbines are disposed in the flow of water in a cascading arrangement.
